(19) United States
(12) Patent Application Publication
(10) Pub. No.: US 2014/0090841 A1
(43) Pub. Date: Apr. 3, 2014

(54) METHODS AND COMPOSITIONS FOR ENHANCED OIL RECOVERY

(71) Applicant: Peter S Piispanen, Stockholm (SE)

(72) Inventor: Peter S Piispanen, Stockholm (SE)

(73) Assignee: ORGANOPETROLEUM PSP AB, Stockholm (SE)

(21) Appl. No.: 14/113,335

(22) PCT Filed: Apr. 25, 2012
(86) PCT No.: PCT/EP2012/057535

§ 371 Date: Dec. 12, 2013

Related U.S. Application Data
(60) Provisional application No. 61/478,971, filed on Apr. 26, 2011.

(30) Foreign Application Priority Data
Apr. 26, 2011 (SE) 1150359-6

(51) Int. Cl. C09K 8/584; E21B 43/16

(52) U.S. Cl. CPC C09K 8/584; E21B 43/16
USPC 166/279; 564/506; 507/244

(57) ABSTRACT

A method of recovering crude oil from a subterranean hydrocarbon-containing formation, comprises the steps: i) injecting into said formation an enhanced oil recovery composition comprising a) a surfactant having the general formula: R1-X—R2, wherein R1 is an open chain sugar alcohol, wherein X is one selected from NH, NCH₃ and NCH₂CH₃, and wherein R2 is an aliphatic or aromatic group comprising at least 5 carbon atoms, b) water, and ii) recovering the crude oil, typically from one or more production wells. One advantage is that the composition is natural product-based. It has superior emulsification, wetting and dispersion capabilities. The composition functions well under heat, pressure, high salinity and high water hardness. The starting materials of the surfactant are renewable and inexpensive. The surfactant is non-toxic and degradable.

### TECHNICAL FIELD

The present invention relates generally to an improved method for enhanced oil recovery as well as an improved composition for enhanced oil recovery.

### BACKGROUND

In the prior art, the substances including 1-deoxy-1-N-octylamino-D-glucitol are known. The substance is for instance disclosed in Journal of Surfactants and Detergents, Volume 7, No 2, pages 147-159 and pages 161-167.

WO 96/28458 discusses a compound like deoxy-1-N-octylamino-D-glucitol as a biocide for instance within industrial applications such as in hydraulic fluid, cooling liquid.

EP 80855 A2 discusses structurally related, but less effective compounds for oil recovery.

Enhanced Oil Recovery are technologies for increasing the amount of crude oil that can be extracted from an oil field. Methods used in the prior art include gas injection, chemical injection, microbial injection and thermal methods.

Enhanced Oil Recovery is described in several publications, for instance:
Speight, J. G. (2009) Enhanced Recovery Methods for Heavy Oil and Tar Sands, Gulf Publishing Company, Houston
Alvarado, V. and Manrique, E. (2010) Enhanced Oil Recovery—Field Planning and Development Strategies, Elsevier, Oxford.
Modern Chemical Enhanced Oil Recovery—Theory and Practice, James J. Sheng, Gulf Professional Publishing, Elsevier, 2011.

For Enhanced Oil Recovery (EOR), both surfactant polymer (SP) and alkali surfactant polymers (ASP) have been used in the prior art. SP and ASP systems comprise use of Alpha-olefin sulfonates, Internal-olefin sulfonates, Alkyl-aryl sulfonates and Alkyl-ether sulfonates. For both those systems a usable maximum oil reservoir temperature is about 70° C. Only in rare cases can the temperature be higher. The water salinity should be below about 35000 ppm. This is clearly a disadvantage since many oil wells have higher temperatures and higher salinity. Problems regarding chemical injection include that the salinity of many oil fields make the extraction less efficient. The temperature in many oil fields is too high with respect to the chemicals used so that the process becomes inefficient. De-emulsifiers are often needed in the prior art.

In addition to high temperature and/or high salinity, problems in the prior art include that the additives are expensive and/or are not renewable. Further, some of the chemicals used today may be toxic and/or non-biodegradable. Further, there is room for improvement regarding the emulsification and dispersion capabilities of the substances according to the state of the art.

### SUMMARY

It is an object of the present invention to obviate at least some of the disadvantages in the prior art and to provide an improved method for enhanced oil recovery as well as an improved composition for enhanced oil recovery.

In a first aspect there is provided a method of recovering crude oil from a subterranean hydrocarbon-containing formation, said method comprising the steps:
i) injecting into said formation an enhanced oil recovery composition comprising
   a) a surfactant having the general formula R1-X—R2;
      wherein R1 is an open chain sugar alcohol;
      wherein X is one selected from NH, NCH₃ and NCH₂CH₃; and
      wherein R2 is an aliphatic or aromatic group comprising at least 5 carbon atoms;
   b) water; and
ii) recovering the crude oil.

In a second aspect there is provided use of a composition comprising
a) a surfactant having the general formula R1-X—R2;
   wherein R1 is an open chain sugar alcohol;
   wherein X is one selected from NH, NCH₃ and NCH₂CH₃; and
   wherein R2 is an aliphatic or aromatic group comprising at least 5 carbon atoms; and
b) a solvent;
   in oil recovery.

In a third aspect there is provided an oil recovery composition comprising
a) a surfactant having the general formula: R1-X—R2, wherein R1 is an open chain sugar alcohol, wherein X is one selected from NH, NCH₃ and NCH₂CH₃, and wherein R2 is an aliphatic or aromatic group comprising at least 5 carbon atoms,
b) a solvent.

Further aspects and embodiments are defined in the appended claims, which are specifically incorporated herein by reference.

One advantage of an embodiment is that there is provided a new, natural product-based substance. By adding it to the pumping water used in tertiary oil recovery, more oil can be recovered from a well.

The composition has superior emulsification (of oil), wetting and dispersion capabilities. Further the properties with regard to formation of foam are favourable. When the composition is mixed with oil the formation of foam is reduced.

The composition functions well under heat, pressure, high salinity and high water hardness. A reservoir temperature of 60-100° C. is possible. A salinity of up to 300000 ppm is also possible. For reservoirs under pressure a temperature of 60-115° C. is possible, provided that the pressure is so high that there is still a liquid water solution.

The starting materials of the surfactant are inexpensive and at least partly renewable.

The surfactant is non-toxic, degradable and reusable.

In most application there is no need for de-emulsifiers.

It is not necessary to use organic solvents. Water is used as a solvent which is advantageous both from an economic point of view and from an environmental point of view.

Another advantage is that the disclosed surfactant does not readily absorb to mineral surfaces, which reduces the loss of surfactant for instance in a recycled system.

### BRIEF DESCRIPTION OF THE DRAWINGS

The invention is now described, by way of example, with reference to the accompanying drawings, in which:

FIG. 1a shows the chemical structure of 1-deoxy-1-octylamino-D-glucitol. Alternatively, the structure may be named N-octyl-D-glucamine.

FIG. 1b shows the chemical structure of 1-deoxy-1-octyl-(2-)amino-D-glucitol. Alternatively, the structure may be named N-(1-methylheptyl)-D-glucamine or N-(2-octyl)-D-glucamine.

FIG. 1c shows the chemical structure of 1-deoxy-1-octyl-(3-)amino-D-glucitol. Alternatively, the structure may be named N-(1-ethylhexyl)-D-glucamine or N-(3-octyl)-D-glucamine.

FIG. 1d shows the chemical structure of 1-deoxy-1-benzylamino-D-glucitol. Alternatively, the structure may be named N-benzyl-D-glucamine.

FIG. 1e shows the chemical structure of 1-deoxy-1-dodecylamino-D-glucitol. Alternatively, the structure may be named N-dodecyl-D-glucamine.

FIG. 1f shows the chemical structure of 1-deoxy-1-(4-trans-)octenylamino-D-glucitol. Alternatively, the structure may be named N-oct-4-trans-enyl-D-glucamine.

### DETAILED DESCRIPTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

The term “about” as used in connection with a numerical value throughout the description and the claims denotes an interval of accuracy, familiar and acceptable to a person skilled in the art. Said interval is ±10%.

“Crude oil” is used herein to denote a naturally occurring mixture consisting of a complex mixture of hydrocarbons of various molecular weights and other organic compounds that are typically found in geologic formations beneath the Earth's surface.

“Hydrocarbon” is used herein to denote an organic compound comprising hydrogen and carbon.

“Sugar alcohol” is used herein to denote a hydrogenated form of a carbohydrate whose carbonyl group has been reduced to a primary or secondary hydroxyl group. An open chain sugar alcohol refers to a sugar alcohol which is not cyclic.

In a first aspect there is provided a method of recovering crude oil from a subterranean hydrocarbon-containing formation, said method comprising the steps:
i) injecting into said formation an enhanced oil recovery composition comprising
   a) a surfactant having the general formula R1-X—R2;
      wherein R1 is an open chain sugar alcohol;
      wherein X is one selected from NH, NCH₃ and NCH₂CH₃; and
      wherein R2 is an aliphatic or aromatic group comprising at least 5 carbon atoms;
   b) water; and
ii) recovering the crude oil.

In one embodiment of this aspect, the recovery of crude oil in step ii) is from one or more production wells.

In one embodiment the connecting bond between R1 and R2 consists of an amine bond. In one embodiment the surfactant is a secondary amine. In an alternative embodiment the surfactant is a tertiary amine. The free rotation ability of the bond (—NH—, —NCH₃— or —NCH₂CH₃—), in contrast with for example ester and amide bonds, combined with the hydrogen bonding property of the amino bond, ensures potentially effective micellar packing. The choice of using one of the above bonds, in contrast to an ester or amide bond, also makes the molecule exceptionally stable towards hydrolysis, as well as reasonably stable against heat degradation.

In one embodiment of this aspect, the surfactant is recycled to said formation after recovering of the crude oil. Preferably the pH is measured and the pH is adjusted if desired. In one embodiment the same surfactant solution is used to recover oil from different wells. Experiments show that even after 5 repeats using the same solution the recovery rate is not decreased or essentially not decreased. Since the pH of the solution in one embodiment with recycling is reduced with each run or when used with an acidic oil well, additional base needs to be added to ensure that the pH of the used solution stays within optimal working conditions.

In one embodiment of this aspect, the pH is in the range from 8 to 11.5. In one embodiment of this aspect, the pH is above 8. In another embodiment of this aspect, the pH is above 9. In yet another embodiment of this aspect, the pH is above 9.5. In one embodiment of this aspect, the pH of said oil removal composition is adjusted to about the pKa-value of the surfactant (which is 9.8 for 1-deoxy-1-octylamino-D-glucitol), for optimal recovery. In one of this aspect, embodiment the pH is in the range from 9 to 11.5. In one embodiment of this aspect, the pH is in the range from 9.5 to 11.5.

In one embodiment of this aspect, where X is an amine moiety, acidification can be used to change the properties of the surfactant. In one embodiment of this aspect, where X is an amine, crude oil is recovered by lowering the pH. In one embodiment of this aspect, where X is an amine, the mixture recovered from the production well is acidified. In one embodiment of this aspect, where X is an amine the mixture recovered from the production well is acidified during a period of time. The solution of the inventive system can be completely cleared of oil by acidification, after which it can be made basic again and reused for another round where X is an amine. Thus the innovation requires fewer solutions since its macroemulsified oil (most oil in the emulsions) separates with no additions necessary when the solution is cooled down. This simplifies the recovery as well as it reduces the time required for recovery and the costs involved.

In one embodiment of this aspect, R1 is selected from the group consisting of mannitol, sorbitol, galactitol, iditol, allitol, altriol, gulitol and talitol. In one embodiment of this aspect, R1 is selected from the group consisting of mannitol, sorbitol, galactitol, and iditol. In one embodiment of this aspect, R1 is sorbitol. Regarding enantiomers both the D and L molecules are encompassed. For instance sorbitol encompasses both D-sorbitol and L-sorbitol. In one embodiment of this aspect, R1 is further modified with at least one entity consisting of a sugar group. For R1 also other monosaccarides will function well as will slightly modified sugars and di-, tri-. etc. up to about ten sugars—modifications which increase the aqueous solubility of the surfactant—that do not disturb micellar packing, i.e. the sugar alcohol should be open chain.

In one embodiment of this aspect, X is NH.

In one embodiment of this aspect, R2 is unbranched. In an alternative embodiment R2 is branched. The molecular structure is preferably linear to avoid micellar curvature and enable dense packing.

In one embodiment of this aspect, R2 is saturated. In an alternative embodiment R2 is unsaturated.

In one embodiment of this aspect, R2 comprises 5-13 carbon atoms. In one embodiment of this aspect, R2 comprises 5-12 carbon atoms. In one embodiment of this aspect, R2 comprises 7-13 carbon atoms. In one embodiment of this aspect, R2 comprises 8-12 carbon atoms. In one embodiment of this aspect, R2 comprises 8 carbon atoms.

In one embodiment of this aspect, said surfactant is selected from 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol; 1-deoxy-1-dodecylamino-D-glucitol; and 1-deoxy-1-(4-trans-)octenylamino-D-glucitol.

In one embodiment of this aspect, said surfactant is 1-deoxy-1-octylamino-D-glucitol.

In a second aspect there is provided use of a composition comprising
a) a surfactant having the general formula R1-X—R2;
   wherein R1 is an open chain sugar alcohol;
   wherein X is one selected from NH, NCH₃ and NCH₂CH₃; and
   wherein R2 is an aliphatic or aromatic group comprising at least 5 carbon atoms; and
b) a solvent;
   in oil recovery.

In one embodiment of this aspect, said use is to recover crude oil from a subterranean hydrocarbon-containing formation.

In one embodiment of this aspect, said use is to recover crude oil is from one or more production wells.

In one embodiment of this aspect, R1 is selected from the group consisting of mannitol, sorbitol, galactitol, and iditol.

In one embodiment of this aspect, R1 is sorbitol.

In one embodiment of this aspect, R1 is further modified with at least one entity consisting of a sugar group of up to around ten sugar moieties, which increases the aqueous solubility of the surfactant.

In one embodiment of this aspect, R2 is unbranched. In one embodiment of this aspect, R2 is branched. In one embodiment of this aspect, R2 is saturated.

In one embodiment of this aspect, R2 is unsaturated.

In one embodiment of this aspect, R2 comprises 7-13 carbon atoms. In one embodiment of this aspect, R2 comprises 5-13 carbon atoms. In one embodiment of this aspect, R2 comprises 5-12 carbon atoms. In one embodiment of this aspect, R2 comprises 8-12 carbon atoms. In one embodiment of this aspect, R2 comprises 8 carbon atoms.

In one embodiment of this aspect, R2 is aromatic.

In one embodiment of this aspect, R2 is non-aromatic.

In one embodiment of this aspect, said surfactant is selected from 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol; 1-deoxy-1-dodecylamino-D-glucitol; and 1-deoxy-1-(4-trans-)octenylamino-D-glucitol.

In one embodiment of this aspect, said surfactant is 1-deoxy-1-octylamino-D-glucitol.

In a fourth aspect there is provided an oil recovery composition comprising a) a surfactant having the general formula: R1-X—R2, wherein R1 is an open chain sugar alcohol, wherein X is one selected from NH, NCH₃ and NCH₂CH₃, and wherein R2 is an aliphatic or aromatic group comprising at least 5 carbon atoms, b) a solvent.

In one embodiment of this aspect, said surfactant is selected from 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol; 1-deoxy-1-dodecylamino-D-glucitol; and 1-deoxy-1-(4-trans-)octenylamino-D-glucitol; and water.

In one embodiment of this aspect, said surfactant is selected from 1-deoxy-1-octyl-(2-)amino-D-glucitol; 1-deoxy-1-octyl-(3-)amino-D-glucitol; and 1-deoxy-1-(4-trans-)octenylamino-D-glucitol.

In a fifth aspect there is surfactant selected from 1-deoxy-1-octyl-(2-)amino-D-glucitol; 1-deoxy-1-octyl-(3-)amino-D-glucitol; and 1-deoxy-1-(4-trans-) octenylamino-D-glucitol.

Without wishing to be bound by any particular scientific theories the inventor believes that the surfactant has its considerable surface activity due to its very effective packing, partly made available by the open sugar. The ability of the connecting bond (the amine moiety) to form hydrogen bonds, like with the structurally similar amides, but not esters and ethers, do, may also be essential for effective packing. The surfactant is capable of lowering aqueous surface tension down to about an amazing 20 dynes/cm; this strongly reduced surface tension makes for a very good emulsifier of oil. It is known that surfactants used in EOR preferably should be able to form Winsor III systems with the oil, and certain concentrations of the surfactant, salt and oil do indeed produce such systems. Furthermore, its pronounced wetting and dispersion properties help.

Still without wishing to be bound by any particular scientific theories the inventor believes that the invention used for enhanced oil recovery employs the same mechanistic principles as in micellar polymer flooding, i.e. the surfactant releases oil from the pores of the reservoir rock (presumably by a roll-up mechanism) so that it can be flushed away by flowing water. The inventive systems easily form micro- and macroemulsions with oil upon heating. However, the macroemulsified oil separates kinetically from the solution upon cooling, while the microemulsified oil, under thermodynamic control can be easily separated by acidification if desired.

The molecular structure of the surfactant is preferably linear to avoid excessive micellar curvature and enable dense packing. This is facilitated by both the open sugar and the amine connecting bond, unique to this invention.

Buffering with a base is advantageous in many cases since it enables the high pH levels required for the non-protonated amine moiety, and thus high and optimal recovery effect.

The basic amine bond helps keeping the pH of the surfactant solution high (above neutral), which keeps the concentration of hydroxide ions high and available for reaction with the acidic parts of the oil component, thus producing further surface active compounds from the oil itself.

Due to the absence of ionic components in the surfactant—practically being a non-ionic surfactant—it does not interact strongly with mineral surfaces, salts or hard water, and so completely avoids many of the problems traditional, ionic surfactants have.

The following table illustrates that the present technology as described herein is superior to SP and ASP systems as used in the prior art regarding for instance temperature, water hardness and water salinity.

Screening Parameters for Surfactant-Polymer & Alkali-Surfactant-
Polymer Systems with comparisons

| | | | Example | present |
|---|---|---|---|---|
| | SP | ASP | Texas Well | Technology |
| Reservoir Temp. | <70° C. (1) | <70° C. (1) | 75° C. | 60-100° C. |
| Oil Density at surface | — | >850 | 925 | 939.2 tested |
| (kg/m3) | | | | |
| Live oil viscosity at | <150 | <150 | 4.2 | 43.3 tested |
| Pb, mPa * s | | | | |
| Horisontal | >50 | >50 | 300-1 500 | — |
| permeability, md | | | | |
| Water Hardness, ppm | <1 000 | <20 (2) | 1 953 | <4 000 |
| Water salinity, ppm | <35 000 (3) | <35 000 (3) | 8.567 | <300 000 |
| Current oil saturation, | 0.350 | 0.350 | 0.542 | — |
| fraction | | | | |

(1) best ever reported is 90° C.
(2) best ever reported is 350 ppm
(3) best ever reported is 200 000 ppm
Source: PRIze analytical simulator
SP = Surfactant-Polymer system
ASP = Alkali-Surfactant-Polymer system

Other features and uses of the invention and their associated advantages will be evident to a person skilled in the art upon reading the description and the examples.

It is to be understood that this invention is not limited to the particular embodiments shown here. The following examples are provided for illustrative purposes and are not intended to limit the scope of the invention since the scope of the present invention is limited only by the appended claims and equivalents thereof.

### Examples

### Experimental Procedure

A laboratory setup was made to simulate enhanced oil recovery. In the experiments crude oil and salt are smeared onto a plastic matrix to simulate the contents of an oil well; in the simplest possible setup, thick crude oil (47.5 mg for sample #1-22) and 48 mg for sample #24-32) and sodium chloride (6 mg) for samples 12-21 & 31-38, and even more in samples 39-47 are smeared into a weighed, plastic Eppendorff tube (1.5 mL) with a cap. To this is added a pre-prepared surfactant solution (5 mg surfactant dissolved in 1 mL of water) and the oil tube is sealed. Glu1=1-deoxy-1-octylamino-D-glucitol, Glu2=1-deoxy-1-octyl-(2-)amino-D-glucitol, Glu3=1-deoxy-1-octyl-(3-)amino-D-glucitol, Glu4=1-deoxy-1-benzylamino-D-glucitol, Glu5=1-deoxy-1-dodecylamino-D-glucitol and Glu6=1-deoxy-1-(4-trans-)octenylamino-D-glucitol. DeHabPEG=polyethyleneglucol-2000-dehydroabietate ester. The contents are heated to +70° C. and the tube shaken for a while—this effectively forms micro- and macroemulsions of the oil into a greyish to blackish water surfactant solution and forms some pressure inside the tube—after which all the contents of the oil tube are poured out. The emptied oil tube is carefully dried, enabling weighing of the non-recovered oil left in the tube. This procedure thus simulates turbulent flooding of a hot well, where emulsified oil is recovered. The oil had an API oil gravity of 19.2.

The used surfactant solution can be stored and upon cooling, the oil in the macroemulsion phase will separate and lay on the top of the solution (being easily recoverable). The then greyish surfactant solution with remaining microemulsions can be reused at least five more times in new oil recovery with good effect. The microemulsions can be completely separated by acidification (re-basification then recreates a new, active surfactant solution). The water hardness was in some experiments adjusted by the addition of calcium carbonate and/or magnesium nitrate to the oil tube.

When dissolving the surfactant, it was done in pure, distilled water with no salts present. Present salt in the dissolution stage slows down the dissolving of surfactant and micellization. Salt can be added later to the dissolved solution if required.

All EOR samples were capped, resulting in some pressure at heated temperature—this is simulating real conditions to some degree. The air volume inside the tubes is slightly more than 0.5 mL, and the solution volume is 1 mL.

Surfactant concentration in samples was 0.5 w/v-% unless otherwise specified.

All samples were repeated twice; results are almost always identical. If differing, another sample is run to determine the outlier sample, which result is thus discarded.

When dissolving the surfactant, only pure, distilled water with no salts present is used. Present salt in the dissolution stage prevents dissolving of surfactant and micellization. Salty solutions can be added later to dissolved solution if needed.

All EOR samples were capped, resulting in some pressure at heated temperature—this is simulating real conditions to some degree. The air volume inside the tubes is slightly more than 0.5 mL, and the solution volume is 1 mL.

The samples comprised the following compounds: sodium chloride (6 mg in samples 12-22 & 33-38 and variable in 1-9, 24-32, 39-47 & 49-53), surfactant (5 mg in all samples except #25-32) and oil (47.5 or 48 mg in all samples except #33-38 & 48).

Throughout the many experiments all the important parameters have been screened to determine the limits of the technology. The experimental ranges have been: surfactant (0-0.5 w/v-%), monovalent salt (sodium chloride: 0-30 w/v %), water hardness (0-4000 ppm) and oil to water volume ratio (0.05-2). Additionally, some different additives have been tested to boost recovery (including Borax, phosphate, Pluronic® P 123 and F127Prill surfactants (BASF) block co-polymers), but with little effect. For a summary of the obtained recovery in all of these experiments, see the tables.

The samples and the results are summarized in the table below:

| | Surfactant and | | Amounts | Oil recovered | | | |
|---|---|---|---|---|---|---|---|
| | additive in 1 mL | Conc. | oil in tube | from tube 2 | | | |
| Sample | solution in tube 1 | (w/v-%) | 2 in g | (%) | R1 type | X type | R2 type |
| 1 | Glu1 | 0.5 | 0.0475 g | 98.11 | open | amine | straight |
| | | | oil | | sugar | | aliphatic |
| 9 | Glu1 | 0.5 | 0.0475 g | 95.79 | | | |
| | | | oil | | | | |
| | DeHabPEG- | 0.5 | | | | | |
| | 2000 ester | | | | | | |
| 12 | Glu1 | 0.5 | 0.0475 g | 92.84 | | | |
| | | | oil | | | | |
| | Na₂HPO₄ | 0.5 | 0.006 g | | | | |
| | x7H₂O | | NaCl | | | | |
| 13 | Glu1 | 0.5 | 0.0475 g | 90.95 | | | |
| | | | oil | | | | |
| | Na₂B₄O₇x | 0.5 | 0.006 g | | | | |
| | 10H₂O | | NaCl | | | | |
| 14 | Glu1 | 0.5 | 0.0475 g | 78.53 | | | |
| | | | oil | | | | |
| | | | 0.060 g | | | | |
| | | | NaCl | | | | |
| 15 | Glu1 | 0.5 | 0.095 g | 85.68 | | | |
| | | | oil | | | | |
| | | | 0.006 g | | | | |
| | | | NaCl | | | | |
| 16 | Glu1 | 0.5 | 0.190 g | 92.37 | | | |
| | | | oil | | | | |
| | | | 0.006 g | | | | |
| | | | NaCl | | | | |
| 17 | Glu1 | 0.5 | 0.380 g | 90.68 | | | |
| | | | oil | | | | |
| | | | 0.006 g | | | | |
| | | | NaCl | | | | |
| 18 | Glu1 | 0.5 | 0.0475 g | 85.47 | | | |
| | | | oil | | | | |
| | P123BASF | 0.5 | 0.006 g | | | | |
| | | | NaCl | | | | |
| 19 | Glu1 | 0.5 | 0.0475 g | 75.37 | | | |
| | | | oil | | | | |
| | F127Prill | 0.5 | 0.006 g | | | | |
| | | | NaCl | | | | |
| 20 | Glu1 | 0.5 | 0.0475 g | | | | |
| | | | oil | | | | |
| | | | 0.006 g | Emulsion | | | |
| | | | NaCl | dissolves by | | | |
| | | | | addition of acid | | | |
| 21 | Glu1 | 0.5 | 0.0475 g | | | | |
| | | | oil | | | | |
| | | | 0.006 g | Emulsion | | | |
| | | | NaCl | stabilizes by | | | |
| | | | | addition of base | | | |

EFFECT OF SURFACTANT CONCENTRATION

| | | | | |
|---|---|---|---|---|
| 24 | Glu1 | 0.5 | 0.048 g | 93.75 |
| | | | oil | |
| 25 | Glu1 | 0.25 | 0.048 g | 89.58 |
| | | | oil | |
| 26 | Glu1 | 0.125 | 0.048 g | 85.42 |
| | | | oil | |
| 27 | Glu1 | 0.0625 | 0.048 g | 85.42 |
| | | | oil | |
| 28 | Glu1 | 0.03125 | 0.048 g | 72.92 |
| | | | oil | |
| 29 | Glu1 | 0.15625 | 0.048 g | 66.67 |
| | | | oil | |
| 30 | Glu1 | 0.07813 | 0.048 g | 64.58 |
| | | | oil | |
| 31 | Glu1 | 0.03906 | 0.048 g | 60.42 |
| | | | oil | |
| 32 | nothing/ | 0 | 0.048 g | 22.92 |
| | control | i.e. pure | oil | |
| | | water | | |

LOAD CAPACITY TESTS

| | | | | |
|---|---|---|---|---|
| 33 | Glu1 | 0.5 | 0.0475 g | 91.58 |
| | | | oil | |
| | | | 0.006 g | |
| | | | NaCl | |
| 34 | Glu1 | 0.5 | 0.760 g | 88.55 |
| | | | oil | |
| | | | 0.006 g | |
| | | | NaCl | |
| 35 | Glu1 | 0.5 | 0.500 g | 82.2 |
| | | | oil | |
| | | | 0.006 g | |
| | | | NaCl | |
| 36 | Glu1 | 0.5 | 0.095 g | 91.58 |
| | | | oil | |
| | | | 0.006 g | |
| | | | NaCl | |
| 37 | Glu1 | 0.5 | 0.667 g | 84.63 |
| | | | oil | |
| | | | 0.006 g | |
| | | | NaCl | |
| 38 | Glu1 | 0.5 | 0.333 g | 81.38 |
| | | | oil | |
| | | | 0.006 g | |
| | | | NaCl | |

EFFECT OF SALT CONCENTRATION

| | | | | |
|---|---|---|---|---|
| 39 | Glu1 | 0.5 | 0.048 g | 89.58 |
| | | | oil | |
| | | | 0.012 g | |
| | | | NaCl | |
| 40 | Glu1 | 0.5 | 0.048 g | 89.58 |
| | | | oil | |
| | | | 0.020 g | |
| | | | NaCl | |
| 41 | Glu1 | 0.5 | 0.048 g | 89.58 |
| | | | oil | |
| | | | 0.030 g | |
| | | | NaCl | |
| 42 | Glu1 | 0.5 | 0.048 g | 89.58 |
| | | | oil | |
| | | | 0.040 g | |
| | | | NaCl | |
| 43 | Glu1 | 0.5 | 0.048 g | 89.58 |
| | | | oil | |
| | | | 0.050 g | |
| | | | NaCl | |
| 44 | Glu1 | 0.5 | 0.048 g | 89.58 |
| | | | oil | |
| | | | 0.006 g | |
| | | | CaCO₃ | |
| 45 | Glu1 | 0.5 | 0.048 g | 89.58 |
| | | | oil | |
| | | | 0.001 g | |
| | | | CaCO₃ | |
| | | | 0.003 g | |
| | | | Mg(NO₃)₂ | |
| | | | x6H₂O | |
| 46 | Glu1 | 0.5 | 0.048 g | 89.58 |
| | | | oil | |
| | | | 0.030 g | |
| | | | NaCl | |
| | | | 0.0014 g | |
| | | | LiOH | |
| 47 | Glu1 | 0.5 | 0.048 g | 89.58 |
| | | | oil | |
| | | | 0.030 g | |
| | | | NaCl | |
| | | | 0.001 g | |
| | | | CaCO₃ | |

FURTHER INFORMATIVE TESTS

| | | | | |
|---|---|---|---|---|
| 48 | Glu1 | 0.5 | 0.333 g | 91.29 |
| | | | oil | |
| | | | 0.006 g | |
| | | | NaCl | |
| 49 | Glu1 | 0.5 | 0.048 g | 98.96 |
| | | | oil | |
| | | | 0.050 g | |
| | | | NaCl | |
| 50 | Glu1 | 0.5 | 0.048 g | 89.58 |
| | | | oil | |
| | | | 0.060 g | |
| | | | NaCl | |
| 51 | Glu1 | 0.5 | 0.048 g | 89.58 |
| | | | oil | |
| | | | 0.100 g | |
| | | | NaCl | |
| 52 | Glu1 | 0.5 | 0.048 g | 89.58 |
| | | | oil | |
| | | | 0.200 g | |
| | | | NaCl | |
| 53 | Glu1 | 0.5 | 0.048 g | 83.33 |
| | | | oil | |
| | | | 0.300 g | |
| | | | NaCl | |

STRUCTURAL DERIVATIVES OF THE INVENTION

| | | | | | | | |
|---|---|---|---|---|---|---|---|
| 55 | Glu2 | 0.5 | 0.0475 g | 90.11 | open | amine | branched |
| | | | oil | | sugar | | aliphatic |
| 56 | Glu3 | 0.5 | 0.048 g | 95.83 | open | amine | branched |
| | | | oil | | sugar | | aliphatic |
| 57 | Glu4 | <0.5 | 0.048 g | 62.5 | open | amine | aromatic |
| | | | oil | | sugar | | |
| 58 | Glu5 | 0.5 | 0.048 g | 75 | open | amine | long |
| | | | oil | | sugar | | straight |
| | | | | | | | aliphatic |
| 59 | Glu6 | 0.5 | 0.048 g | 95.83 | open | amine | unsaturated |
| | | | oil | | sugar | | aliphatic |

COMPARATIVE STUDIES

| | | | | | | |
|---|---|---|---|---|---|---|
| 60 | N-benzyl-D- | 0.048 g | 31.25 | open | amide | aromatic |
| | gluconamide | oil | | sugar | | |
| 61 | N-octyl-D- | 0.048 g | 27.08 | open | amide | aliphatic |
| | gluconamide | oil | | sugar | | |
| 62 | N-cyclohexyl-D- | 0.048 g | 33.33 | open | amide | cyclic |
| | gluconamide | oil | | sugar | | aliphatic |
| 64 | Dodecyltrimethylammonium | 0.048 g | 56.25 | ammonium | cationic | long, |
| | hydrochloride | oil | | | | straight |
| | | | | | | aliphatic |
| 65 | Sodium dodecyl | 0.048 g | 41.67 | sulphate | anionic | long, |
| | sulphate | oil | | | | straight |
| | | | | | | aliphatic |
| 66 | 2-deoxy-2- | 0.048 g | 22.92 | closed/open | amide | terpenoid |
| | dehydroabietoyl- | oil | | sugar | | |
| | amido-D- | | | | | |
| | glucopyranose | | | | | |
| 67 | Polyethyleneglycol | 0.048 g | 50 | polyethylene- | ester | terpenoid |
| | (PEG-2000) ester of | oil | | glycol | | |
| | dehydroabietic acid | | | | | |
| 68 | Octyl-α-D- | 0.048 g | 45.83 | closed | ether | straight |
| | glucopyranoside | oil | | sugar | | alkyl |
| 69 | 2-ethylhexyl-α | 0.048 g | 15.62 | closed | ether | branched |
| | maltopyranoside | oil | | sugar | | alkyl |
| 72 | 6-O-[3:6:9- | 0.048 g | 68 | open/closed | ether | long, |
| | trioxaheneicosyl]-D- | oil | | sugar/triethylene | | straight |
| | galactose | | | | | aliphatic |
| 70 | C12EO5 | 0.048 g | 85.42 | polyethylene- | ether | long, |
| | | oil | | glycol | | straight |
| | | | | | | aliphatic |
| 77 | C12EO5 | 0.048 g | <10 | polyethylene- | ether | long, |
| | | oil | | glycol | | straight |
| | | | | | | aliphatic |
| | | 0.100 g | | | | |
| | | NaCl | | | | |

### Results

Salt tests prove rather conclusively that the type of salt, monovalent or divalent cationics, has no bearing on the degree of oil recovered. The technology for EOR functions in soft and hard water alike.

Also, between 0.5-20 w/v-% salt contents, the recovery rate for the invention surfactants is practically unchanged at around 90%, in sharp contrast with any other commercially available surfactant compared to. Multiple repeat samples give the same results.

Addition of very small amounts of LiOH or NaOH apparently increases the recovery rate at room temperature even if the final total recovery number is lowered. However, there is no recovery loss at higher temperatures and so it can be used in an oil well.

Oil, either smeared onto a plastic surface or mixed into fine washed sand, is seemingly recovered equally well.

Recovering oil—mixed into salty, clumpy sand—is achieved very effectively by first adding the surfactant solution and then adding very, very small amounts of LiOH or NaOH. Addition of base thus facilitates recovery from ‘stuck’ areas.

While heated, oil forms a macroemulsion with the surfactant solution, and almost fully separates when cooled down to room temperature.

The surfactant solution is easily foaming, but this is readily reduced when it comes into contact with crude oil.

Results from Samples 41 and 46 (/w salt, but without and with LiOH) gives identical result—inclusion of LiOH has no effect on the EOR end result, but is believed to initially boost recovery rates at RT, but at the price of a lower total yield. This problem is eliminated at higher temperatures. LiOH is expected to be a possibly useful additive in field.

All samples form blackish macroemulsions when heated and slightly shaken—this simulates turbulent flow in an oil recovery well (heating & water flushing). Shaking the sample simulates turbulent flow in EOR.

### Comparative Experiments

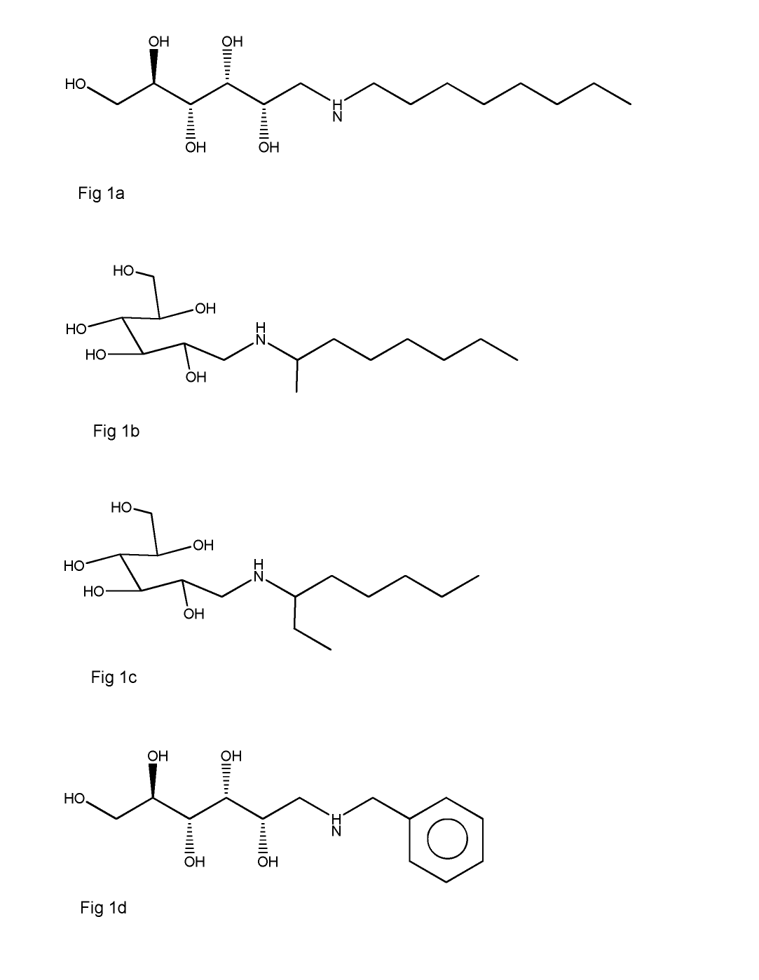

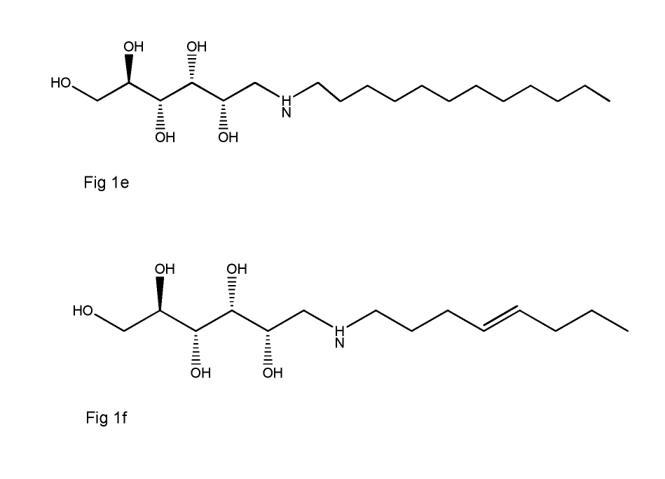

The most effective solution recovers up to 98% of the crude oil content, in comparison to pure water which can only recover up to 23% (similar to the best secondary oil recovery). The various structural derivatives of the invention (FIG. 1a-1f) generally proved to be very effective recovery agents. In contrast, the many other structurally varied surfactants tested for reference (samples 60-77 including one from EP 80855 A2—sample 72), where many of the permutations of R1, X and R2 were tested, gave recovery results ranging only from worse than pure water (≦23%) up to at most 85% in the above setup. The best of these commercial materials (85%), sample 70, proved completely incapable of EOR (<10%), sample 77, in saline conditions in contrast to the invention compounds (cmp. to sample 51 of the invention, which all retain generally high recovery rates even in hard water or highly saline conditions).

1. A method of recovering crude oil from a subterranean hydrocarbon-containing formation, said method comprising the steps:
i) injecting into said formation an enhanced oil recovery composition comprising
a) a surfactant having the general formula R1-X—R2;
wherein R1 is an open chain sugar alcohol;
wherein X is selected from the group consisting of NH, NCH₃ and NCH₂CH₃; and
wherein R2 is an aliphatic or aromatic group comprising at least 5 carbon atoms;
b) water; and
ii) recovering the crude oil.

2. The method according to claim 1, wherein the recovery of crude oil in step ii) is from one or more production wells.

3. The method according to claim 1, wherein the pH of the composition is above 8.

4. The method according to claim 1, wherein the surfactant is recycled to said formation after recovering of the crude oil.

5. The method according to claim 1, wherein X is selected from the group consisting of NH, NCH₃, and NCH₂CH₃, and wherein crude oil is recovered by lowering the pH.

6. The method according to claim 1, wherein R1 is selected from the group consisting of mannitol, sorbitol, galactitol, iditol, allitol, altritol, gulitol, and talitol.

7. The method according to claim 1, wherein R1 is sorbitol.

8. The method according to claim 1, wherein R1 is further modified with at least one entity consisting of a sugar group of up to around ten sugar moieties, which increases the aqueous solubility of the surfactant.

9. The method according to claim 1, wherein X is NH.

10. The method according to claim 1, wherein R2 is unbranched.

11. The method according to claim 1, wherein R2 is branched.

12. The method according to claim 1, wherein R2 is saturated.

13. The method according to claim 1, wherein R2 is unsaturated.

14. The method according to claim 1, wherein R2 is aromatic.

15. The method according to claim 1, wherein R2 is non-aromatic.

16. The method according to claim 1, wherein R2 comprises 5-13 carbon atoms.

17-19. (canceled)

20. The method according to claim 1, wherein said surfactant is selected from the group consisting of 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol; 1-deoxy-1-dodecylamino-D-glucitol; and 1-deoxy-1-(4-trans-)octenylamino-D-glucitol.

21-39. (canceled)

40. An oil recovery composition comprising a surfactant selected from the group consisting of 1-deoxy-1-octylamino-D-glucitol; 1-deoxy-1-octyl-(2-)amino-D-glucitol; 1-deoxy-1-octyl-(3-)amino-D-glucitol; 1-deoxy-1-benzylamino-D-glucitol; 1-deoxy-1-dodecylamino-D-glucitol; and 1-deoxy-1-(4-trans-)octenylamino-D-glucitol; and water.

41. The oil recovery composition according to claim 40, wherein said surfactant is selected from the group consisting of 1-deoxy-1-octyl-(2-)amino-D-glucitol; 1-deoxy-1-octyl-(3-)amino-D-glucitol; and 1-deoxy-1-(4-trans-)octenylamino-D-glucitol.

42. A surfactant selected from the group consisting of 1-deoxy-1-octyl-(2-)amino-D-glucitol; 1-deoxy-1-octyl-(3-)amino-D-glucitol; and 1-deoxy-1-(4-trans-)octenylamino-D-glucitol.
